(19) United States
(12) Patent Application Publication
(10) Pub. No.: US 2006/0126199 A1
(43) Pub. Date: Jun. 15, 2006

(54) Color wheel and its manufacturing method

(75) Inventor: Yan-Jun Jia, Dong-Guan City (CN)

Correspondence Address: TROXELL LAW OFFICE PLLC;SUITE 1404, 5205 LEESBURG PIKE, FALLS CHURCH, VA, 22041, US

(73) Assignee: Asia Optical Co., Inc.

(21) Appl. No.: 11/205,100

(22) Filed: Aug. 17, 2005

(30) Foreign Application Priority Data
Dec. 10, 2004 (TW) 093138317

(51) Int. Cl. G03B 21/14; G02B 7/00

(52) U.S. Cl. 359/892; 353/84

(57) ABSTRACT

A color wheel, for use in a Digital Light Processing (DLP), capable of preventing a color filter from escaping away is disclosed. The color wheel includes a motor having a spindle to which a rotating disc is mounted, and a filter element mounted to the rotating disc. The filter element includes a filter ring comprising a plurality of sectors having radially extending edges jointed to each other and forming a joint line between jointed edges, and a positioning ring coaxially mounted to the filter ring to hold the sectors together, the positioning ring being positioned on and fixed to the rotating disc and interposed between the filter ring and the rotating disc to fix the filter ring to the rotating disc.

### BACKGROUND OF INVENTION

1. Field of the Invention

The present invention relates to a color wheel and related manufacture method. More particularly, the present invention relates to a color wheel for use in a Digital Light Processing (DLP), which is capable of preventing the filter film from escaping away and its manufacture method.

2. Description of the Prior Art

Nowadays, there are various kinds of projectors such as a Cathode Ray Tube (CRT) type, a Liquid Crystal Display (LCD) type and a Digital Light Processing (DLP) type. The DLP projector becomes a mainstream product due to its higher brightness, shorter response period, non-noise, and smaller volume. The conventional DLP projector includes a lens for focusing light beams from a lamp to pass through a color wheel, formed by red, green, blue color filter films. Finally, the light beams are projected on a Digital Micro-mirror Device, (DMD). By using such technique, the Digital Micro-mirror Device, replacing a LCD panel in a conventional LCD projector, comprises a plurality of tiny microlens driven by driving electrodes to adjust their incline angle, adjusting a reflective direction of the incident light beam to display an image.

The conventional color wheels in a DLP projector, for instance, disclosed in Taiwan Pat. No. 523113, 523114, 534329, 547672, 580148 and U.S. Pat. Nos. 5,668,572, 5,868,482, and 6,754,014, can generate a full color projected image and comprises an axle cover, a group of color filter films, a rotating disc with a flange, and a motor. The rotating disc is affixed on a pivot of the motor. The color filter film sticks to the rotating disc with glue. In this way, the motor drives the color filter rotating, thereby generating a colorful image as white light beams pass it.

Conventionally, the color filter which has three to six sector filter films sticking directly on the rotating disc of the color wheel using glue. The filter film is made of glass and the rotating disc is made of aluminum or aluminum alloy. Because aluminum (or aluminum alloy), compared to glass, has a larger thermal coefficient, enlargement of the rotating disc is greater than that of the color filter while heating. That leads to a tension applied on each seam of two adjacent filter films to lower sticking strength between them, even producing a crevice. Such crevice not only degrades the predetermined precision requirement, but also becomes more serious due to centrifugal force as the color wheel rotates in high speed, thereby the filter films escaping from the rotating disc. In order to overcome this problem, using a screw to screw the color filter and the rotating disc is a resolution. However, the outer diameter of the rotating disc is very small so that there is no enough space for placing the screw. As a result, it is necessary to provide a new designation to overcome such drawback in conventional structure.

### SUMMARY OF INVENTION

It is therefore an object of the claimed invention to provide a color wheel and its manufacturing method. The color wheel reduce the risk of escaping from the motor as the motor is rotating in a high speed to solve conventional problem.

Briefly summarized, the claimed invention provides a color wheel comprises a motor having a spindle to which a rotating disc is mounted, and a filter element mounted to the rotating disc. The filter element comprises a filter ring comprising a plurality of sectors having radially extending edges jointed to each other and forming a joint line between jointed edges, and a positioning ring coaxially mounted to the filter ring to hold the sectors together, the positioning ring being positioned on and fixed to the rotating disc and interposed between the filter ring and the rotating disc to fix the filter ring to the rotating disc.

According to claimed invention, a method of manufacturing a color wheel with an assembly color filter comprising:
(a) providing a color filter comprising a plurality of filter films, a joint line being defined between two adjacent filter films, a first size variation of the color filter corresponding to an unit temperature change;
(b) providing a positioning ring assembled with the color filter, the color filter extending across each joint line between adjacent filter films bond all the sectors together and forming a filter element, a second size variation of the positioning ring corresponding to the unit temperature range;
(c) providing a rotating disc, a third size variation of the rotating disc corresponding to the unit temperature range; and
(d) mounting the filter element in step (b) to the rotating disc by using a temperature variation procedure with the positioning ring interposed between the color filter and the rotating disc, wherein, in a unit temperature change, an absolute difference value of a first size variation of the color filter and a second size variation of the positioning ring is less than an absolute difference value of the first size variation of the color filter and a third size variation of the rotating disc.

In contrast to prior art, the present invention color wheel comprises a positioning ring which is stuck to the color filter. Then the positioning ring is adhered to the rotating disc of the motor, avoiding a direct contact between the color filter and the rotating disc. In other words, the color filter is stuck to the rotating disc, but adhered to the positioning ring which is affixed to the motor instead. In process of adhering the color wheel onto the rotating disc by heating, the positioning ring absorbs a stress resulting from imbalance expansion of the rotating disc and the color filter. Because the stress applied on the seam between the two adjacent filter films is lowered, an adhering strength between the two adjacent filter films may not be reduced. As a result, a seam between two adjacent color films may not generate, not only meeting precision and strength requirement for assemble, but also preventing the color filter from escaping away as the color wheel is rotating.

These and other objects of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a color wheel according to the present invention.

FIG. 2 shows a diagram of a filter element of the color wheel depicted in FIG. 1.

FIG. 3 is a cross-section view of the color wheel with a motor according to present invention.

### DETAILED DESCRIPTION

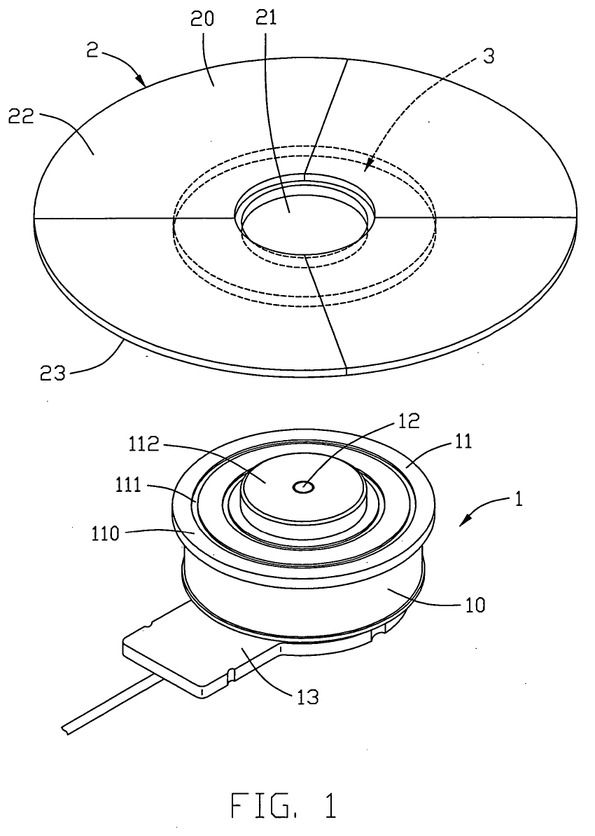

Referring to FIG. 1, a color wheel constructed in accordance with the present invention comprises a motor 1, a color filter 2, and a positioning ring 3. The motor 1 comprises a housing 10, a spindle 12, and a rotating disc 11 affixed on the spindle 12 to be rotatable in unison therewith. The spindle 12 and the rotating disc 11 are driven by the motor 12. The rotating disc 11 comprises a joint face 110 in which a circular recess 111 surrounding the spindle 12 is formed for. The rotating disc 11 further comprise a cylindrical protrusion 112 with a central bore (not labeled in FIG. 1) fit over spindle 12, for affixing the rotating disc 11 to the motor 1.

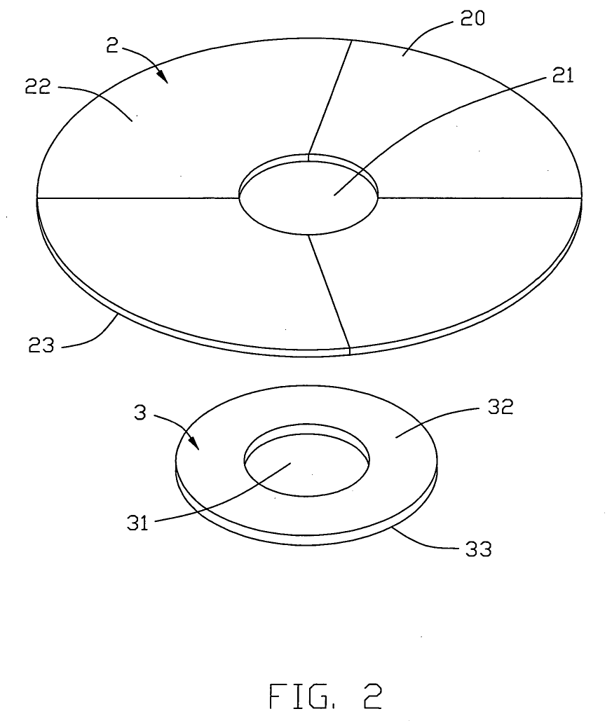

Also referring to FIG. 2, the color filter 2 is a ring-like flat member, comprising a plurality of sectors made of glass having radially extending edges jointing to each other. Radially extending joint lines are thus defined by the jointed edges of the sectors. The flat member of color filter 2 has a first surface 22 and a second surface 23. A central bore 21 having a diameter larger than an outer diameter of the protrusion 112 is formed in the center of the color filter 2.

The positioning ring 3 and the color filter 2 are made of materials having the same or similar thermal coefficient of expansion. For example, the positioning ring 3 is made of glass similar to the color filter 2. The positioning ring 3 has a first surface 32 and a second surface 33. A central bore 31 is formed in the center of the positioning ring 3, and the diameter of the bore 31 corresponds to the outer diameter of the protrusion.

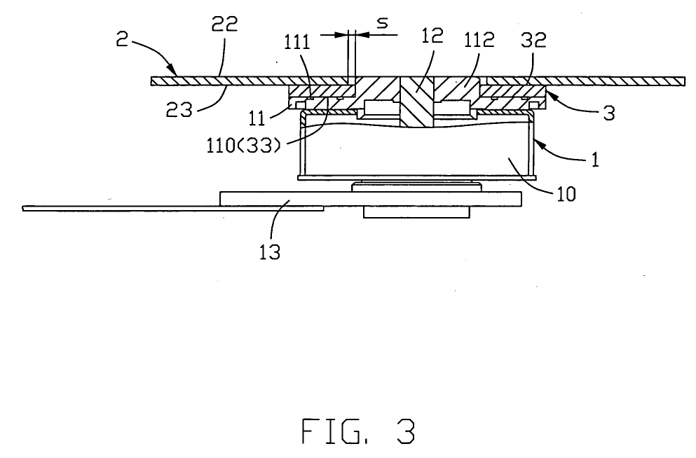

As shown in FIGS. 1 and 3, the first surface 32 of the positioning ring 3 is fixed to the second surface 23 of the color filter 23 by for example adhesives. The positioning ring 3 extends circumferentially across all joint lines between adjacent sectors of the color filter 2 to firmly hold the sectors of the color filter 2. The bore 31 of the positioning ring 3 is concentric to the bore 21 of the color filter 21.

The second surface 33 of the positioning ring 3 is fixed to the joint face 110 of the rotating disc 11 by means of for example adhesives. Overflow of adhesive occurs during mounting the positioning ring 3 to the joint face 110 of the rotating disc 11 is received in the recess 111 defined in the joint face 110 to eliminate undesired contamination.

The protrusion 112 of the rotating disc 11 extends through the bore 31 of the positioning ring 3 and the bore 21 of the color filter 2. Since the bore 21 is larger than the bore 31, a circumferential gap S is formed between the bore 21 and the protrusion 112 for eliminating undesired interference therebetween and enhancing assembling of the color filter 2 to the motor 1. Preferably, the gap has a width between 0.5-1.0 mm.

The motor 1 is fixed on a support panel 13, which is in turn fixed in a device housing in which the color filter 2 is encased.

Based on the above-mentioned structure of the color wheel, the method of manufacturing such a color wheel comprises the following steps:
(a) providing a color filter 2 having a plurality of sectors having radially extending edges jointed to each other to define radially extending joint lines, the color filter 2 having a first size variation corresponding to a unit temperature change. The size variation corresponding to a unit temperature change indicates an amount of size variation with respect to a temperature change of 1 degree centigrade.
(b) providing a positioning ring 3, which is mounted to the color filter 2, the color filter 3 comprising a ring-like flat body extending across each joint line between adjacent filter sectors 20 to bond all the sectors together and forming a filter element, the positioning ring 3 having a second size variation corresponding to a unit temperature change.
(c) providing a rotating disc 11, the rotating disc 11 having a third size variation corresponding to a unit temperature change.
(d) mounting the filter element to the rotating disc 11 by using a temperature variation procedure with the positioning ring 3 interposed between the color filter 2 and the rotating disc 11. It is noted that, in a unit temperature change, the difference between the first size variation of the color filter 2 and the second size variation of the positioning ring 3 is less than the difference between the first size variation of the color filter 2 and the third size variation of the rotating disc 11.

Because the color filter 2 and the positioning ring 3 have similar thermal coefficients of expansion, an approximate amount of expansion may be obtained by heating, meeting precision and strength requirement for assemble. It is noted that, in this preferred embodiment, the color filter 2 is stuck on the positioning ring 3. Thereafter, adhere the positioning ring 3 on the rotating disc 11, and keep a gap S between the color filter 2 and the positioning ring 3 to prevent the color filter 2 from contacting with the joint face 110 of the rotating disc 11. In process of adhering the color wheel onto the rotating disc by heating, the positioning ring 3 absorbs a stress resulting from imbalance expansion of the rotating disc 11 and the color filter 2. Because the stress applied on the seam between the two adjacent filter films 20 is lowered, an adhering strength between the two adjacent filter films 20 may not be reduced. As a result, a seam between two adjacent color films 20 may not generate, not only meeting precision and strength requirement for assemble, but also preventing the color filter from escaping away as the color wheel is rotating.

The present invention has been described with reference to certain preferred and alternative embodiments which are intended to be exemplary only and not limiting to the full scope of the present invention as set forth in the appended claims.

What is claimed is:

1. A color wheel comprising:
a motor having a spindle to which a rotating disc is mounted; and
a filter element mounted to the rotating disc, comprising:
a filter ring comprising a plurality of sectors having radially extending edges jointed to each other and forming a joint line between jointed edges; and
a positioning ring coaxially mounted to the filter ring to hold the sectors together, the positioning ring being positioned on and fixed to the rotating disc and interposed between the filter ring and the rotating disc to fix the filter ring to the rotating disc.

2. The color wheel of claim 1, wherein the positioning ring is fixed to the rotating disc by adhesives and wherein the rotating disc defines a recess for receiving overflow of the adhesives.

3. The color wheel of claim 1, wherein the rotating disc comprises a protrusion defining a hole fit over and coupled to the spindle of the motor for fixing the rotating disc to the spindle of the motor.

4. The color wheel of claim 3, wherein the color filter forms a first central bore fit over the protrusion, the first central bore having a diameter substantially larger than an outer diameter of the protrusion of the rotating disc, whereby a circumferential gap is formed between the protrusion and the first central bore.

5. The color wheel of claim 4, wherein the positioning ring defines a second central bore having a diameter substantially corresponding to the outer diameter of the protrusion of the rotating disc.

6. The color wheel of claim 1 wherein the filter ring and the positioning ring are made of materials having substantially the same thermal coefficients of expansion.

7. A method of manufacturing a color wheel with an assembly color filter comprising:
(a) providing a color filter comprising a plurality of filter films, a joint line being defined between two adjacent filter films, a first size variation of the color filter corresponding to an unit temperature change;
(b) providing a positioning ring assembled with the color filter, the color filter extending across each joint line between adjacent filter films bond all the sectors together and forming a filter element, a second size variation of the positioning ring corresponding to the unit temperature range;
(c) providing a rotating disc, a third size variation of the rotating disc corresponding to the unit temperature range; and
(d) mounting the filter element in step (b) to the rotating disc by using a temperature variation procedure with the positioning ring interposed between the color filter and the rotating disc, wherein, in a unit temperature change, an absolute difference value of a first size variation of the color filter and a second size variation of the positioning ring is less than an absolute difference value of the first size variation of the color filter and a third size variation of the rotating disc.

8. The method of claim 7 wherein a protrusion is located in the center of the rotating disc, and defines a shaft hole for being engaged with a shaft of a driving member to affix the rotating disc with the driving member.

9. The method of claim 8 wherein the color filter in step (a) comprises a first surface, a second surface and an opening, with a diameter of the central bore being larger than the outer diameter of the protrusion.

10. The method of claim 9 wherein the positioning ring in step (b) defines an opening, an outer diameter of the central bore matches with the outer diameter of the protrusion of the rotating disc.

11. The method of claim 10 further comprising: adhering the positioning ring onto the joint face of the rotating disc before step (d).
